(19) United States
(12) Patent Application Publication
(10) Pub. No.: US 2011/0285664 A1
(43) Pub. Date: Nov. 24, 2011

(54) RESISTIVE TOUCH PANEL AND INPUT DEVICE USING THE SAME

(75) Inventor: SONG-LING YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/040,298

(22) Filed: Mar. 4, 2011

(30) Foreign Application Priority Data
May 24, 2010 (CN) 201010181076.0

(51) Int. Cl. G06F 3/045

(52) U.S. Cl. 345/174

(57) ABSTRACT

An input device includes a resistive touch panel, which includes a cover layer as the outermost layer of the touch panel. A conductive layer, a resistance layer including a line-type resistor oriented in a regular shape on the surface of the resistance layer. A substrate, and a plurality of insulation spacers arranged between the conductive layer and the resistance layer to separate the conductive layer from the resistance layer. The line-type resistor includes a first end and a second end. A potential difference is formed between the conductive layer and the resistance layer, when the surface of the touch panel is touched, the conductive layer and the resistance layer are pressed together, and the current at the first end and the second end are changed for the conductive layer is connected to the resistance layer at the touch point.

### BACKGROUND

1. Technical Field

The present disclosure relates to touch panels and, particularly, to a resistive touch panel and an input device using a resistive touch panel.

2. Description of Related Art

Touch panels are transparent or opaque input devices for computers and other electronic systems, and are activated by contacts from a user's finger, a stylus, or a like device.

The dominant touch panel technologies presently in use are resistive, capacitive, infrared, and acoustic touch panels. A typical 4-terminal wires resistive touch panel includes two resistance layers separated by an insulation layer. Display devices employing the touch panels can accurately identify a single touch, but cannot identify more than one touch simultaneously. Furthermore, a 4-terminal wires resistive touch panel needs a complex driving method and a complex driving circuit, which accordingly increases cost.

Therefore, what is needed is a resistive touch panel to overcome the shortcomings of the conventional resistive touch panels.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a side, cross-sectional view of a touch panel of an input device in accordance with an exemplary embodiment, showing a conductive layer, an insulation layer, and a resistance layer of the resistive touch panel.

FIG. 2 is a schematic view of the resistance layer of the touch panel of FIG. 1.

FIG. 3 is a block diagram of the input device using the touch panel according to an exemplary embodiment.

FIG. 4 is a coordinate schematic diagram of the touch panel of the input device of FIG. 1 according to an exemplary embodiment.

FIG. 5 is an equivalent circuit schematic of the resistance layer of the touch panel of FIG. 1, showing one point being touched.

FIG. 6 is an equivalent circuit schematic of the resistance layer of the touch panel of FIG. 1, showing two points being simultaneously touched.

FIG. 7 is an equivalent circuit schematic of the resistance layer of the touch panel of FIG. 1, showing three points being simultaneously touched.

FIG. 8 is a flowchart of the input device using the touch panel according to an exemplary embodiment.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean at least one.

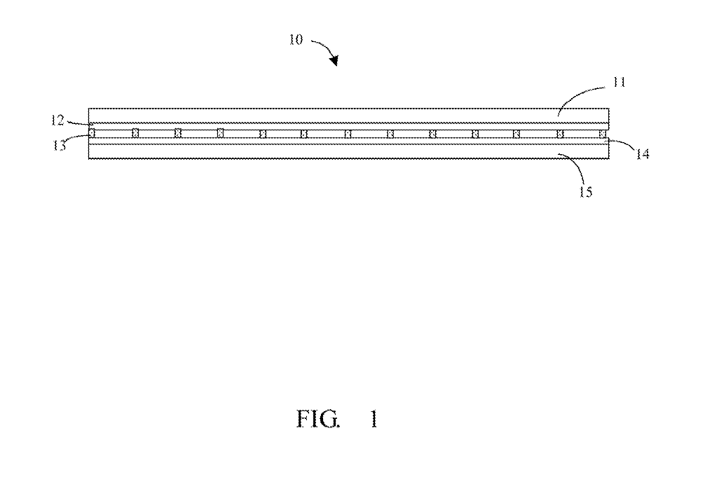

Referring to FIG. 1, an embodiment of a touch panel 10 is illustrated. The touch panel 10 from the top to the bottom includes a cover layer 11, a conductive layer 12, a plurality of insulation spacers 13, a resistance layer 14, and a substrate 15. In this embodiment the touch panel 10 is attached to a display panel (not shown), therefore the touch panel 10 is made of rigid transparent material. In another embodiment, the touch panel 10 can be made of opaque material for touch pad or touch switch.

The cover layer 11 is the outermost layer of the touch panel 10. The cover layer 11 is made of elastic transparent insulated material and the surface is hardened for employing a protective film. The conductive layer 12 is an electrically conductive and resistive layer made with indium tin oxides (ITO) film. The substrate 15 is made of rigid material and is attached to the display panel. A plurality of insulation spacers 13 is arranged between the conductive layer 12 and the resistance layer 14 to separate the conductive layer 12 from the resistance layer 14. The insulation spacer is made of flexible insulated material.

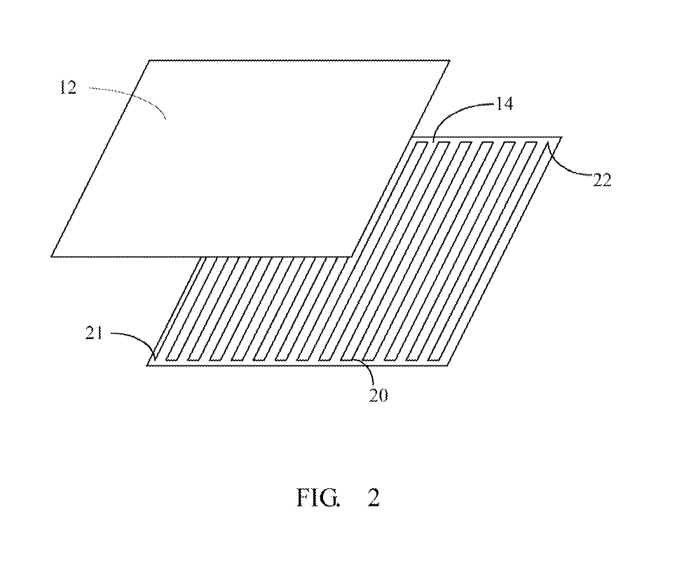

Referring to FIG. 2, a line-type resistor 20 is etched on the surface of the resistance layer 14. The line-type resistor 20 includes a first end 21 and a second end 22, the first end 21 and the second end 22 are arranged on two diagonal corners of the resistance layer 14. The line-type resistor 20 is bent repeatedly from the first end 21 to the second end 22 on the surface of the resistance layer 14, which forms a regular shape, such as a plurality of evenly spaced series lines along one of the sides of the resistance layer 14.

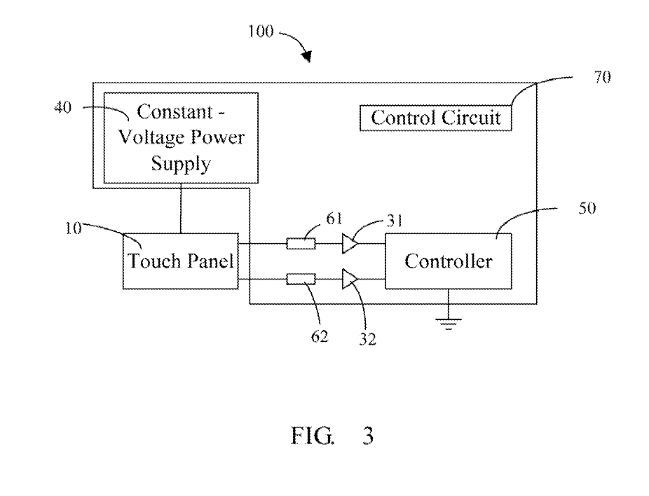

Referring to FIG. 3, an input device 100 includes the touch panel 10 and a control circuit 70. The control circuit 70 includes a first current detector 31, a second current detector 32, a constant-voltage power supply 40 and a controller 50. The conductive layer 12 is electrically connected to the constant-voltage power supply 40 for obtaining a constant-voltage from the power supply 40. The first end 21 of the line-type resistor 20 is connected to the first current detector 31, the second end 22 is connected to the second current detector 32, and the controller 50 is connected to the first current detector 31 and the second current detector 32. When the surface of the touch panel 10 is touched, the conductive layer 12 and the resistance layer 14 are pressed together, therefore the contact point on the resistance layer 14 is connected to the first end 21 and the second end 22. The first current detector 31 and the second current detector 32 are configured to detect the current variation of the first end 21 and the second end 22 and transmit the current variation data to the controller 50. The controller 50 determines the number of the touch points and the touch position according to the current variation data detected by the first current sensor 31 and the second current sensor 32.

In this embodiment, a divider resistor 61 with the resistance of R₁ is connected between the first end 21 and the first current sensor 31, a divider resistor 62 with the resistance of R₂ is connected between the second end 22 and the second current sensor 32. The range of the current detected by the first current sensor 31 and the second current sensor 32 is decreased by using the divider resistor.

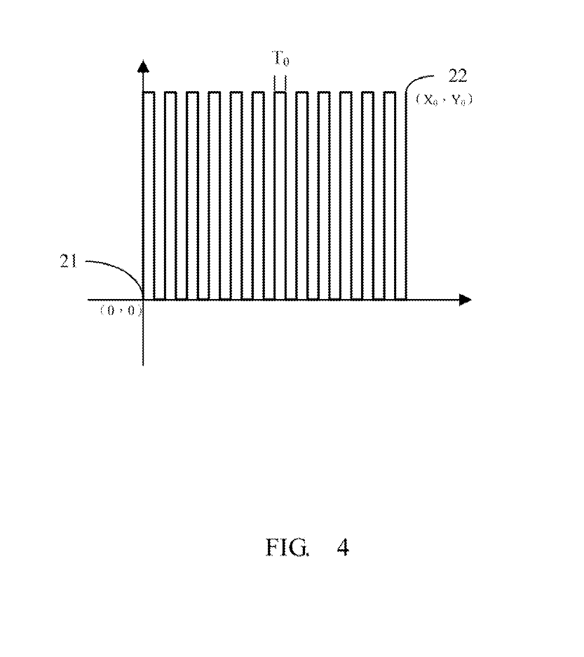

The computing method of the input device 100 is disclosed. Referring to FIG. 4, the length of the line-type resistor 20 is L and the resistance per unit length of the line-type resistor 20 is M₀ Ohms/m. The resistance value of the line-type resistor 20 is constant and is far greater than that of the conductive layer 12. In this embodiment, each of the points of the line-type resistor 20 corresponds to a touchable point of the touch panel 10. The first end 21 is the origin (0, 0) of the touch panel 10 and the coordinate of the second end 22 is (X₀, Y₀), the space between the adjacent series lines is T₀. The voltage provided by the constant-voltage power supply 40 is U. When the surface of the touch panel 10 is touched, the conductive layer 12 and the resistance layer 14 are pressed together, the potential of the touch point A is U, the current value detected by the first current detector 31 is I₁, and the current value detected by the first current detector 31 is I₂.

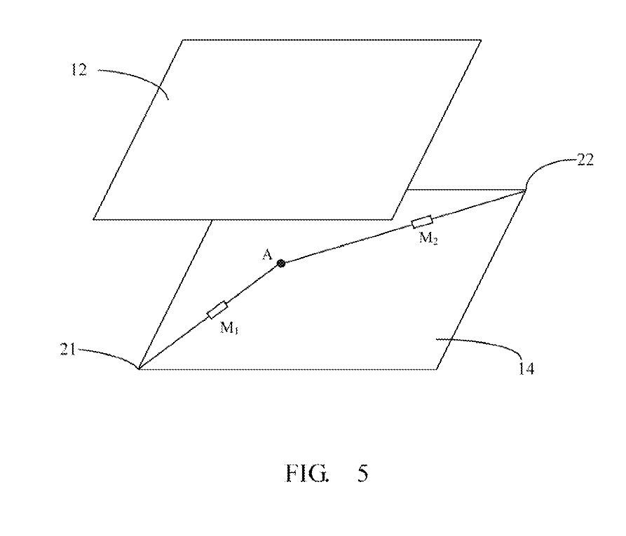

Referring to FIG. 5, only one touch point A is touched on the touch panel 10. The length of the section of the line-type resistor 20 from the touch point A to the first end 21 is L₁, the length of the section of the line-type resistor 20 from the touch point A to the second end 22 is L₂. The resistance value of the section of the line-type resistor 20 from the touch point A to the first end 21 is M₁, and the resistance value of the section of the line-type resistor 20 from the touch point A to the second end 22 is M₂. The equivalent resistor M₁ and M₂ are connected in series, and satisfy the formula M₁+M₂=M₀*L, L₁+L₂=L.

In this embodiment, the controller 50 determines the position of the touch point A according to the current value I₁ detected by the first current sensor 31. The controller 50 determines the resistance value of the equivalent resistor M₁ according to the formula M₁=U/I₁−R₁, and calculates the length of the section of the line-type resistor 20 from the touch point A to the first end 21 according to the formula L₁=M₁/M₀. According the formula L₁=K₁(Y₀+T₀)+L₁₁, L₁ divided by (Y₀+T₀) remains L₁₁ and the quotient is K₁. The controller 50 determines the coordinate of the touch point A according to K₁ and L₁₁:
If L_{11≦Y}₀, and K₁ is an odd number, the coordinate of the touch point A is (K₁T₀, Y₀−L₁₁);
If L₁₁≦Y₀, and K₁ is an even number, the coordinate of the touch point A is (K₁T₀, L₁₁);
If L₁₁>Y₀, and K₁ is an odd number, the coordinate of the touch point A is [K₁T₀+(L₁₁−Y₀), 0];
If L₁₁>Y₀, and K₁ is an even number, the coordinate of the touch point A is [K₁T₀+(L₁₁−Y₀, Y₀].

In another embodiment, the controller 50 determines the position of the touch point A according to the current value I₂ detected by the second current sensor 32, the calculate method is similar to steps described above.

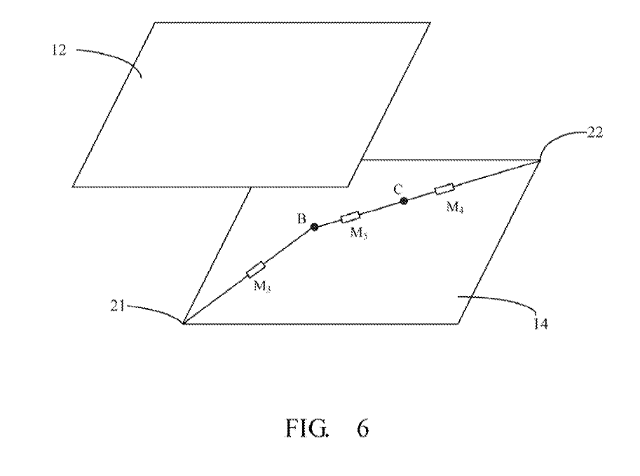

Referring to FIG. 6, two touch points B and C are touched on the touch panel 10, the conductive layer 12 and the resistance layer 14 are pressed together at touch points B and C. The length of the section of the line-type resistor 20 from the touch point B to the first end 21 is L₃, the length of the section of the line-type resistor 20 from the touch point C to the second end 22 is L₄, and the length of the section of the line-type resistor 20 from the touch point B to the touch point C is L₅. The resistance value of the section of the line-type resistor 20 from the touch point B to the first end 21 is M₃, the resistance value of the section of the line-type resistor 20 from the touch point C to the second end 22 is M₄, and the resistance value of the section of the line-type resistor 20 from the touch point B to the touch point C is M₅. The touch points B and C are at the same potential U, therefore the equivalent resistor M₃ and M₄ are connected in series, <<See my comment above>> and the equivalent resistor M₅ is shorted out. The equivalent resistor M₃, M₄ and M₅ satisfied the formula M₃+M₄<M₀*L, L₃+L₄<L.

Similarly, the controller 50 determines the resistance value of the equivalent resistor M₃ and M₄ according to the formula M₃=U/I₁−R₁, M₄=U/I₂−R₂, and calculates the value of the L₃ and L₄ according to the formula L₃=M₃/M₀, L₄=M₄/M₀. According the formula L₃=K₂(Y₀+T₀)+L₂₁, L₃ divided by (Y₀+T₀) remains L₂₁ and the quotient is K₂. According the formula L₄=K₃(Y₀+T₀)+L₃₁, L₄ divided by (Y₀+T₀) remains L₃₁ and the quotient is K₃.

The controller 50 determines the coordinate of the touch point B according K₂ and L₂₁:
If L₂₁≦Y₀, and K₂ is an odd number, the coordinate of the touch point B is (K₂T₀, Y₀−L₂₁);
If L₂₁≦Y₀, and K₂ is an even number, the coordinate of the touch point B is (K₂T₀, L₂₁);
If L₂₁>Y₀, and K₂ is an odd number, the coordinate of the touch point B is [K₂T₀+(L₂₁−Y₀), 0];
If L₂₁>Y₀, and K₂ is an even number, the coordinate of the touch point B is [K₂T₀+(L₂₁−Y₀), Y₀].

The controller 50 determines the coordinate of the touch point C according to K₃ and L₃₁:
If L ₃₁≦Y₀, and K₃ is an odd number, the coordinate of the touch point C is (K₃T₀, L₃₁);
If L₃₁≦Y₀, and K₃ is an even number, the coordinate of the touch point C is (K₃T₀, Y₀−L₃₁);
If L₃₁>Y₀, and K₃ is an odd number, the coordinate of the touch point C is [K₃T₀+(L₃₁−Y₀), Y₀];
If L₃₁>Y₀, and K₃ is an even number, the coordinate of the touch point C is [K₃T₀+(L₃₁−Y₀), 0].

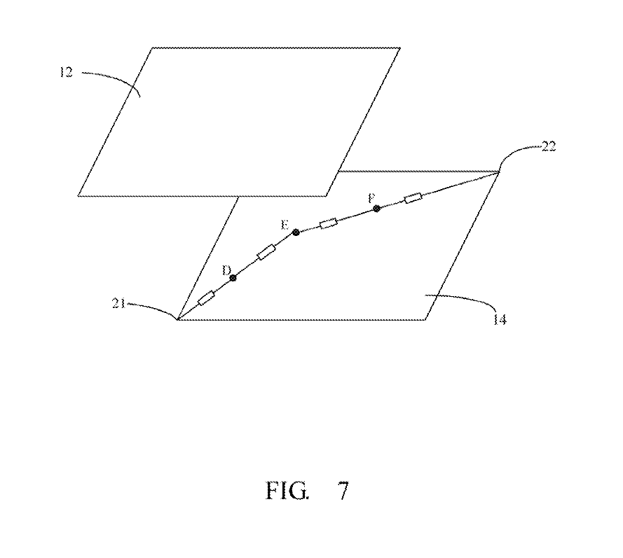

Referring to FIG. 7, three touch points D, E and F are touched on the touch panel 10, the conductive layer 12 and the resistance layer 14 are pressed together at touch points D, E and F. The touch points D, E and F are at the same potential U, therefore the section of the line-type resistor 20 from the touch point D to the touch point E and the section of the line-type resistor 20 from the touch point F to the touch point E are shorted out, the section of the line-type resistor 20 from the touch point D to the first end 21 and the section of the line-type resistor 20 from the touch point F to the second end 22 are connected in series. The controller 50 determines the position of the touch point D according to the current value I₁ detected by the first current sensor 31, and determines the position of the touch point F according to the current value I₂ detected by the first current sensor 32 as the calculate steps described before.

If more than one touch point is touched between the touch points D and F, the touch point between the touch points D and F is at the same potential U, therefore the section of the line-type resistor 20 between the touch points D and F is shorted out. Therefore, if more than three touch points are touched on the touch panel 10. The coordinate that is determined by the controller 50 corresponding to the current value I₁ is the position of the touch point nearest to the first end 21 according to the length of the section of the line-type resistor 20 from the touch point to the first end 21. Similarly, the coordinate determined by the controller 50 that is corresponding to the current value I₂ is the position of the touch point nearest to the first end 22.

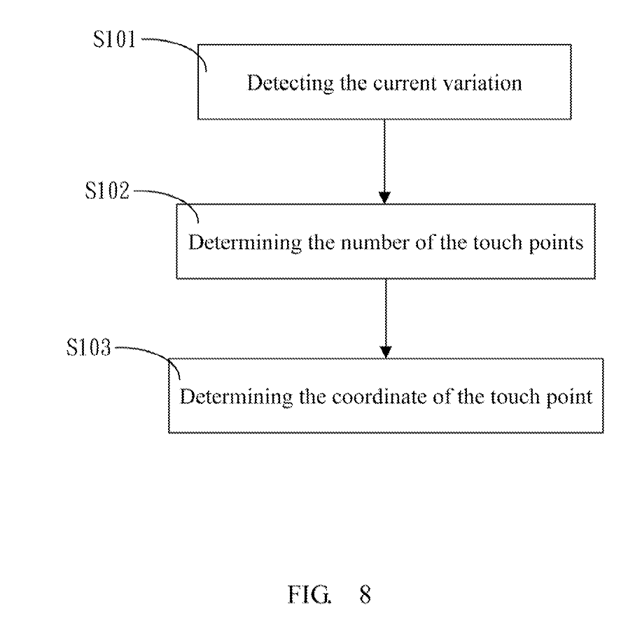

Referring to FIG. 8, a flowchart of a control method is applied in the input device 100 using the touch panel 10.

In step S101, the first current detector 31 and the second current detector 32 detect the current variation of the first end 21 and the second end 22 and transmits the current variation data to the controller 50.

In step S102, the controller 50 determines the number of the touch points on the touch panel 10 according to the current variation data.

If the touch panel 10 is not touched, the conductive layer 12 does not conduct to the resistance layer 14, the current value detected by the first current sensor 31 and the second current sensor 32 is zero. When the surface of the touch panel 10 is touched, the conductive layer 12 and the resistance layer 14 are pressed together, the potential of the touch point A is U, the current value detected by the first current detector 31 is I₁. The current value detected by the first current detector 31 is I₂.

The controller 50 determines the number of the touch points according to the current value I₁ and I₂:
If I₁=0, I₂=0, the touch panel 10 is not touched;
If I₁≠0, I₂≠0, the controller 50 determines resistance value Mₐ of the section of the line-type resistor 20 from the first end 21 to the touch point nearest to the first end 21 according to the formula Mₐ=U/I₁−R₁, and determines resistance value M_{b} of the section of the line-type resistor 20 from the first end 21 to the touch point nearest to the second end 22 according to the formula M_{b}=U/I₂−R₂. If resistance value M₁ and M₂ satisfied the formula M₁+M₂=M₀*L, only one touch point is touched on the touch panel 10. If resistance value M₁ and M₂ satisfy the formula M₁+M₂<M₀*L, at least two touch points are touched on the touch panel 10.

In step S103, the controller 50 determines the coordinates of the one or more touch points according to the current value detected by the first current sensor 31 and the second current sensor 32.

If only one touch point is touched on the touch panel 10, the controller 50 determines that the position of the touch point according to the current value I₁ (also can be I₂). If two touch points are touched on the touch panel 10, the controller 50 determines that the position of the touch points according to the current value I₁ and I₂. If more than two touch points are touched on the touch panel 10, the controller 50 determines the position of the touch point nearest to the first end 21 according to the current value I₁, and determines the position of the touch point nearest to the second end 22 according to the current value I₂.

Each of the points of the line-type resistor 20 corresponds to a touchable point of the touch panel 10, the current value I₁ corresponding to the position of the touch point nearest to the first end 21, and the current value I₂ corresponding to the position of the touch point nearest to the second end 22. In another embodiment, the input device 100 further includes a memory, a relation table including the relationship between the current value I₁, I₂, the coordinate of the touch point is stored in the memory. The controller 50 determines the position of the touch point by seeking the coordinate corresponding to the current values detected by the first current sensor 31 and the second current sensor 32.

In other embodiments, the line-type resistor 20 can be arranged as another regular shape, the proper coordinate of the touch point can be calculated via the current value detected by the first current sensor 31 and the second current sensor 32.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A resistive touch panel, comprising:
a cover layer being the outermost layer of the touch panel;
a conductive layer;
a resistance layer comprising a line-type resistor oriented in a regular shape on the surface of the resistance layer, and the line-type resistor comprising a first end and a second end;
a substrate; and
a plurality of insulation spacers arranged between the conductive layer and the resistance layer to separate the conductive layer from the resistance layer;
wherein a voltage is formed between the conductive layer and the resistance layer, when the surface of the touch panel is touched, the conductive layer and the resistance layer are pressed together, and the current at the first end and the second end varies for the conductive layer is connected to the resistance layer at the touch point, the variations of the current is detected to determine the position of the touch point.

2. The resistive touch panel according to claim 1, wherein the a plurality of insulation spacers is made of flexible insulated material.

3. The resistive touch panel according to claim 1, wherein the line-type resistor forms a plurality of evenly spaced series lines along one of the sides of the resistance layer, and each of the points of the line-type resistor corresponds to a touchable point of the resistive touch panel.

4. The resistive touch panel according to claim 1, wherein the first end and the second end are arranged on two diagonal corners of the resistance layer.

5. An input device comprising:
a resistive touch panel comprising:
a cover layer being the outermost layer of the touch panel;
a conductive layer;
a resistance layer comprising a line-type resistor oriented in a regular shape on the surface of the resistance layer, and the line-type resistor comprising a first end and a second end;
a substrate; and
a plurality of insulation spacers arranged between the conductive layer and the resistance layer to separate the conductive layer from the resistance layer;
a first current sensor connected to the first end and a second current sensor connected to the second end;
a constant-voltage power supply configured to supply a constant-voltage to the conductive layer; and
a controller;
wherein a potential difference is formed between the conductive layer and the resistance layer, when the surface of the touch panel is touched, the conductive layer is connected to the resistance layer at the contact point, the first current sensor and the second current sensor detects the current variations of the first end and the second end and transmits the current variation data to the controller, the controller determines the number of the touch points and the touch position according to the current variation data detected by the first current sensor and the second current sensor.

6. The input device according to claim 5, wherein a plurality of insulation spacers is made of flexible insulated material.

7. The input device according to claim 5, wherein the line-type resistor forms a plurality of evenly spaced series lines along one of the sides of the resistance layer, and each of the points of the line-type resistor corresponds to a touchable point of the resistive touch panel.

8. The input device according to claim 7, wherein the first end and the second end are arranged on two diagonal corners of the resistance layer

9. The input device according to claim 5, wherein a divider resistor is connected between the first end and the first current sensor, a divider resistor is connected between the second end and the second current sensor.

10. The input device according to claim 5, wherein the input device further comprises a memory storing a table including various coordinates of the touch point on the input device corresponding to the current values detected by the first current sensor and the second current sensor.

11. A display device comprising:
a resistive touch panel comprising:
a cover layer being the outermost layer of the touch panel;
a conductive layer;
a resistance layer comprising a line-type resistor oriented in a regular shape on the surface of the resistance layer, and the line-type resistor comprising a first end and a second end;
a substrate; and
a plurality of insulation spacers arranged between the conductive layer and the resistance layer to separate the conductive layer from the resistance layer;
a first current sensor connected to the first end and a second current sensor connected to the second end;
a constant-voltage power supply configured to supply a constant-voltage to the conductive layer;
a controller configured to determine the number of the touch points and the touch position according to the current variation data detected by the first current sensor and the second current sensor; and
a display panel configured to display visual information corresponding to the touch.

12. The display device according to claim 11, wherein a plurality of insulation spacers is made of flexible insulated material.

13. The display device according to claim 11, wherein the line-type resistor follows a plurality of evenly spaced series lines along one of the sides of the resistance layer, and each of the points of the line-type resistor corresponds to a touchable point of the resistive touch panel.

14. The display device according to claim 13, wherein the first end and the second end are arranged on two diagonal corners of the resistance layer.

15. The display device according to claim 11, wherein a divider resistor is connected between the first end and the first current sensor, a divider resistor is connected between the second end and the second current sensor.

16. The display device according to claim 11, wherein the input device further comprises a memory storing a table including various coordinate of the touch point on the input device corresponding to the current value detected by the first current sensor and the second current sensor.
